(19) United States
(12) Patent Application Publication
(10) Pub. No.: US 2023/0173684 A1
(43) Pub. Date: Jun. 8, 2023

(54) EMBEDDED SYSTEM FOR DEXTEROUS HAND

(71) Applicant: SHENZHEN DORABOT INC., Shenzhen, Guangdong (CN)

(72) Inventors: Tao Wang, Shenzhen, Guangdong (CN); Zheng Xie, Shenzhen, Guangdong (CN); Yuan Li, Shenzhen, Guangdong (CN); Shuqu Chen, Shenzhen, Guangdong (CN); Zhongying Huang, Shenzhen, Guangdong (CN)

(21) Appl. No.: 17/920,046

(22) PCT Filed: May 13, 2021
(86) PCT No.: PCT/CN2021/093509

§ 371 Date: Oct. 20, 2022

(30) Foreign Application Priority Data
Jun. 30, 2020 (CN) 202021231274.9

(51) Int. Cl. B25J 13/02; H04L 12/40; B25J 13/08; B25J 15/08

(52) U.S. Cl. CPC B25J 13/02; H04L 12/40032; B25J 13/08; B25J 15/08; H04L 2012/40215

(57) ABSTRACT

The invention discloses an embedded system for dexterous hand, comprising: a central communication unit, several fingers, a palm; wherein the central communication unit communicates with the fingers, the palm and a host computer, and is configured to receive an operation instruction from the host computer, and convert the operation instruction into a control instruction and send it to the fingers and the palm; the fingers and the palm are designed to be compatible in hardware structure, and are connected by serial communication; the fingers and the palm move according to the control instructions. The fingers and palm are designed as embedded compatibility standards, which makes the dexterous hand more flexible and easy to maintain and use with lower cost. Thus, the dexterous hand has the advantages of high flexibility, high reliability, strong anti-interference, low cost, high transmission speed, convenient maintenance, and good user experience.

### FIELD OF THE INVENTION

The invention pertains to the field of dexterous hands, in particular to an embedded system for dexterous hand.

### BACKGROUND OF THE INVENTION

In the prior art, dexterous hands are generally designed in a modular manner to ensure good flexibility. At present, the existing dexterous hands have a complex structure. In order to pursue high-precision control, high-cost embedded solutions are often used. For example, the FPGA+DSP solution has a relatively high cost, resulting in a high cost of the dexterous hand. Moreover, as the modularization is not standardized, maintenance will become very difficult, and it is also difficult to achieve consistent performance.

In addition, in the process of use, it does not support online replacement of fingers in order to ensure higher communication rates and communication stability, and the impact of electrical shocks also needs to be considered, resulting in poor user experience.

### SUMMARY OF THE INVENTION

The purpose of the invention is to solve the problems in the prior art. In accordance with an aspect of the embodiment, there is provided an embedded system for dexterous hand. The fingers and palm are designed as embedded compatibility standards, which makes the dexterous hand more flexible and easy to maintain, flexible to use, convenient to maintain. The maintenance and using cost of the dexterous hand is effectively reduced. The dexterous hand has the advantages of high flexibility, high reliability, strong anti-interference, low cost, high transmission speed, convenient maintenance, and good user experience.

In accordance with an aspect of the embodiment, the system comprise a central communication unit, several fingers, a palm; wherein the central communication unit communicates with the fingers, the palm and a host computer, the central communication unit is configured to receive an operation instruction from the host computer, and convert the operation instruction into a control instruction and send it to the fingers and the palm; the fingers and the palm are designed to be compatible in hardware structure, and are connected by serial communication; the fingers and the palm move according to the control instructions.

Alternatively, the finger comprises a first joint module, a second joint module, and a first micro-control unit; the first joint module includes a first joint and a first DC motor connected thereto, the first DC motor drives the first joint to move; the second joint module includes a second joint and a second DC motor connected thereto, the second DC motor drives the second joint to move; the first micro-control unit includes a first DC motor driver chip, the first DC motor driver chip includes multiple pulse width modulation (PWM) outputs; the first DC motor and the second DC motor are respectively connected with one PWM output of the first DC motor driver chip; the first micro-control unit receives the operation instruction sent by the central communication unit via a CAN bus, and converts the operation instruction into the control instruction to control and drive the first DC motor and the second DC motor respectively via two PWM outputs of the first DC motor driver chip, so as to control and drive the first joint connected to the first DC motor and the second joint connected to the second DC motor to move according to the control instruction of the first micro-control unit.

Alternatively, finger further includes a first motor current sensor and a second motor current sensor; the first motor current sensor configured to sample the motor driving current of the first DC motor, the actual current value received by the first joint is obtained after sampling is provided to the first micro-control unit and converted; the second motor current sensor configured to sample the motor driving current of the second DC motor, the actual current value received by the second joint is obtained after sampling is provided to the first micro-control unit and converted.

Alternatively, the first joint module further includes a first position sensor and a first joint pressure sensor; the first position sensor is embedded in the first joint for detecting the accurate angle of the first joint when the first DC motor drives the first joint to move; the first joint pressure sensor is installed at the middle position of the first joint for detecting a pressure value received by the first joint, and transmitting the pressure value to the first micro-control unit.

Alternatively, the second joint module further includes a second position sensor and a second joint pressure sensor; the second position sensor is embedded in the second joint for detecting the accurate angle of the second joint when the second DC motor drives the second joint to move; the second joint pressure sensor is installed at the middle position of the second joint for detecting a pressure value received by the second joint, and transmitting the pressure value to the first micro-control unit.

Alternatively, the finger further includes a first voltage slow-start protection circuit for countering the impact of a counter electromotive force caused by the frequent starting of the DC motor.

Alternatively, the finger further includes a first anti-shock protection circuit for countering the impact of a power shock when the finger is connected.

Alternatively, the palm includes a third joint module and a second micro-control unit; the third joint module includes a third joint and a third DC motor, the third DC motor drives the third joint to move; the second micro-control unit includes a second DC motor driver chip, the second DC motor driver chip includes multiple PWM outputs; the third DC motor is connected to one output of the second DC motor driver chip; the second micro-control unit receives the operation instruction sent by the central communication unit via a CAN bus, and converts the operation instruction into the control instruction to control and drive the third DC motor via one channel of PWM output of the second DC motor driver chip, so as to control and drive the third joint connected to the third DC motor to move according to the control instruction of the second micro-control unit.

Alternatively, the palm further includes a third motor current sensor, a third position sensor and a third joint pressure sensor; the third motor current sensor configured to sample the motor driving current of the third DC motor, provided to the second micro-control unit for sampling, and then converted to obtain the actual current of the third joint; the third position sensor is embedded in the third joint for detecting the accurate angle of the third joint when the third DC motor drives the third joint to move; the third joint pressure sensor is installed at the middle position of the third joint for detecting the pressure value received by the third joint, and transmitting the pressure value to the second micro-control unit.

Alternatively, the palm further includes a second voltage slow-start protection circuit for countering the impact of a counter electromotive force caused by the frequent starting of the DC motor.

Alternatively, the palm further includes a second anti-shock protection circuit for countering the impact of a power shock when the palm is connected.

Alternatively, the central communication unit is further configured to read and forward a response data of each finger and the palm, and upload the response data to the host computer.

Compared with the prior art, the present invention provides an embedded system for dexterous hand, the system comprising: a central communication unit, several fingers, a palm; wherein the central communication unit communicates with the fingers, the palm and a host computer, and is configured to receive an operation instruction from the host computer, and convert the operation instruction into a control instruction and send it to the fingers and the palm; the fingers and the palm are designed to be compatible in hardware structure, and are connected by serial communication; the fingers and the palm move according to the control instructions. In the present invention, the fingers and palm are designed as embedded compatibility standards, which makes the dexterous hand more flexible and easy to maintain, flexible to use, convenient to maintain. The maintenance and using cost of the dexterous hand is effectively reduced. The central communication unit, the fingers, the palm and the host computer are connected by serial communication, the fingers and palm are designed as embedded compatibility standards, making the inquiry response communication reliable and ensure the stability of communication, so that the dexterous hand has the advantages of high flexibility, high reliability, strong anti-interference, low cost, high transmission speed, convenient maintenance, and good user experience.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic view of an embedded system for dexterous hand according to an embodiment of the present invention;

FIG. 2 is a schematic view of the dexterous hand according to the present invention;

FIG. 3 is a schematic view of the embedded system according to the present invention;

FIG. 4 is a schematic view of motor control of the embedded system according to the present invention;

FIG. 5 is a schematic view of the palm in the embedded system according to the present invention;

FIG. 6 is a schematic view of the embedded system for dexterous hand in data communication according to the present invention.

### DETAILED DESCRIPTION OF THE INVENTION

The invention will be further described below in details with reference to the figures and embodiments.

In the following description, suffixes such as “module”, “component” or “unit” used to denote elements are defined only to facilitate the description of the present invention, and have no specific meaning in themselves. Therefore, “module”, “component” or “unit” is used alternatively.

It should be explained that the term “first” and “second” in the description, claims and the above drawings of the present invention are used to distinguish similar objects, instead of describing specific sequences or order.

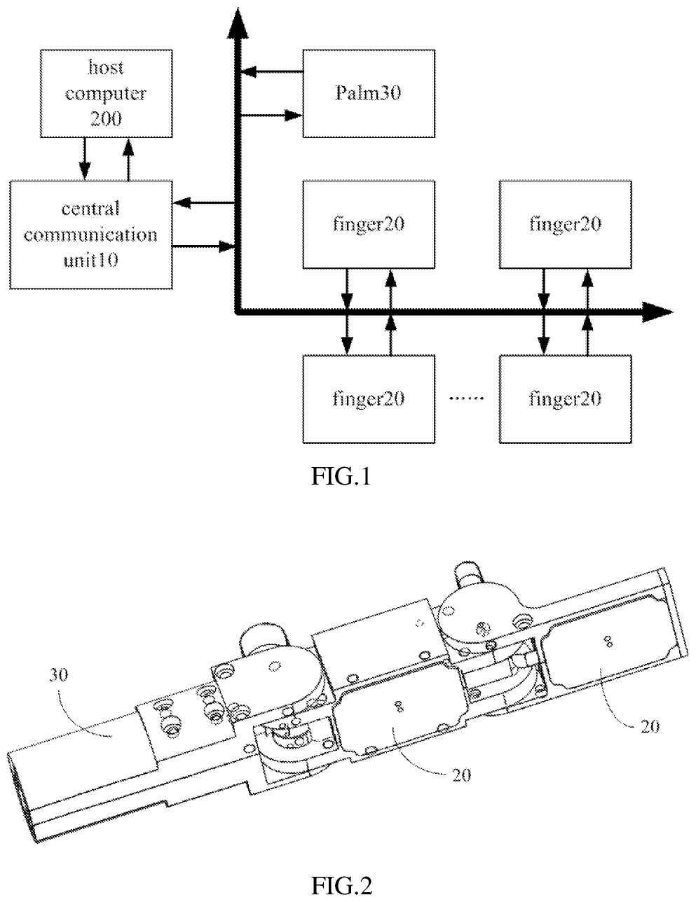

Please refer to FIG. 1 and FIG. 2, the specific structure of a preferred embodiment of the present invention is shown, which is an embedded system for dexterous hand. The system includes a central communication unit 10, several fingers 20, and a palm 30.

The central communication unit 10 communicates with the fingers 20, the palm 30 and a host computer 200, the central communication unit 10 is configured to receive an operation instruction from the host computer 200, and convert the operation instruction into a control instruction and send it to the fingers 20 and the palm 30, and is further configured to read and forward a response data of each finger 20 and the palm 30.

The fingers 20 and the palm 30 are designed to be compatible in hardware structure, and are connected by serial communication.

The fingers 20 and the palm 30 move according to the control instructions.

In this embodiment, the fingers and palm are designed as embedded compatibility standards, which makes the dexterous hand more flexible and easy to maintain, flexible to use, convenient to maintain. The maintenance and using cost of the dexterous hand is effectively reduced.

The central communication unit, the fingers, the palm and the host computer are connected by serial communication, the fingers and palm are designed as embedded compatibility standards, making the inquiry response communication reliable and ensure the stability of communication, so that the dexterous hand has the advantages of high flexibility, high reliability, strong anti-interference, low cost, high transmission speed, convenient maintenance, and good user experience.

Preferably, the central communication unit 10 is communicated with the fingers 20, the palm 30 and the host computer 200 by the serial communication (CAN (controller area network) bus), therefore, the dexterous hand has the effects of high reliability, strong anti-interference, low cost and high transmission speed (up to 1 Mbps).

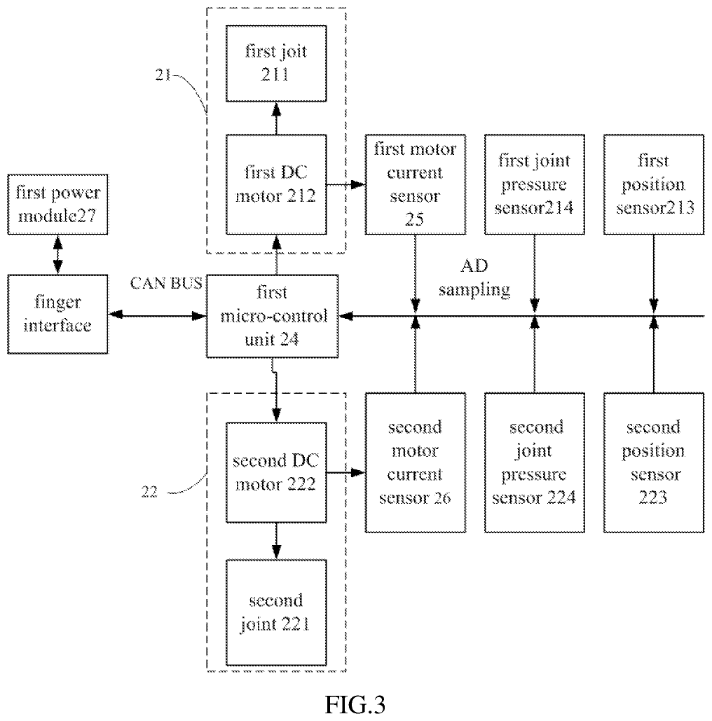

In one embodiment as shown in FIG. 3, the finger 20 includes a first joint module 21, a second joint module 22, and a first micro-control unit (MCU, Micro Control University) 24.

The first joint module 21 includes a first joint 211 and a first DC motor 212 connected thereto, the first DC motor 212 drives the first joint 211 to move.

The second joint module 22 includes a second joint 221 and a second DC motor 222 connected thereto, the second DC motor 222 drives the second joint 221 to move.

The first micro-control unit 24 includes a first DC motor driver chip, the first DC motor driver chip includes multiple pulse width modulation (PWM) outputs.

The first DC motor 212 and the second DC motor 222 are respectively connected with one PWM output of the first DC motor driver chip.

The first micro-control unit 24 receives the operation instruction sent by the central communication unit 10 via a CAN bus, and converts the operation instruction into the control instruction to control and drive the first DC motor 212 and the second DC motor 222 respectively via two PWM outputs of the first DC motor driver chip 241, so as to control and drive the first joint 211 connected to the first DC motor 212 and the second joint 221 connected to the second DC motor 222 to move according to the control instruction of the first micro-control unit 24.

In this embodiment, the fingers are directly driven by multi-motors, effectively ensuring the control performance. The fingers use a micro control unit as a processor to control the multi-motors of the fingers, therefore, the first micro-control unit controls and drives the first DC motor and the second DC motor respectively by two PWM outputs of the first DC motor driver chip, so as to control and drive the first joint connected to the first DC motor and the second joint connected to the second DC motor to move according to the control instruction of the first micro-control unit. Therefore, the dexterous hand has the advantages of high flexibility, high reliability, strong anti-interference, low cost and convenient maintenance.

In one embodiment as shown in FIG. 3, the finger 20 further includes a first motor current sensor 25. The first motor current sensor 25 is serially connected with the first DC motor 212, configured to sample the motor driving current of the first DC motor 212. After the motor driving current is amplified (e.g., amplified by an operational amplifier), the actual current value received by the first joint 211 is obtained after sampling is provided to the first micro-control unit 24 and converted.

Preferably, the finger 20 further includes a second motor current sensor 26. The second motor current sensor 26 is serially connected to the second DC motor 222 for sampling the motor driving current of the second DC motor 222. After the motor driving current is amplified (e.g., amplified by an operational amplifier), the actual current value received by the second joint 221 is obtained after sampling is provided to the first micro-control unit 24 and converted.

Preferably, the first joint module 21 further includes a first position sensor 213; the first position sensor 213 is embedded in the first joint 211 for detecting the accurate angle of the first joint 211 when the first DC motor 212 drives the first joint 211 to move. Alternatively, the first position sensor 213 is a hall sensor.

Preferably, the second joint module 22 further includes a second position sensor 223; the second position sensor 223 is embedded in the second joint 221 for detecting the accurate angle of the second joint 221 when the second DC motor 222 drives the second joint 221 to move. Alternatively, the second position sensor 223 is a hall sensor.

Preferably, the first joint module 21 further includes a first joint pressure sensor 214, the first joint pressure sensor 214 is installed at the middle position of the first joint 211 for detecting a pressure value received by the first joint 211, and transmitting the pressure value to the first micro-control unit 24. Specifically, when the first joint 211 is stressed, the first joint pressure sensor 214 detects the change of the resistance value of the first joint 211, and passes the change of the resistance value via a piezoelectric conversion circuit, the actual pressure value received by the first joint 211 is obtained after sampling is provided to the first micro-control unit 24 and converted. Preferably, the first joint pressure sensor 214 is a resistance strain pressure sensor. Furtherly, the first joint pressure sensor 214 is a resistance strain pressure sensor array.

Preferably, the second joint module 22 further includes a second joint pressure sensor 224, the second joint pressure sensor 224 is installed at the middle position of the second joint 221 for detecting a pressure value received by the second joint 221, and transmitting the pressure value to the first micro-control unit 24. Specifically, when the second joint 221 is stressed, the second joint pressure sensor 224 detects the change of the resistance value of the second joint 221, and passes the change of the resistance value via the piezoelectric conversion circuit, the actual pressure value received by the second joint 221 is obtained after sampling is provided to the first micro-control unit 24 and converted. Preferably, the second joint pressure sensor 224 is a resistance strain pressure sensor. Furtherly, the second joint pressure sensor 224 is a resistance strain pressure sensor array.

In this embodiment, the finger includes a variety of sensors such as a current sensor, a position sensor, and a pressure sensor. The micro-control unit acts as a processor to sample various sensors of the fingers, the control of multiple target parameters of the modular finger can be realized, so that the dexterous hand has the advantages of high flexibility, high reliability, strong anti-interference, low cost and convenient maintenance.

In one embodiment as shown in FIG. 3, the finger 20 further includes a first power module 27 for providing power to the finger 20. Preferably, the first power module 27 provides the finger 20 with DC 12V/24V power.

Preferably, the finger 20 further includes a first voltage slow-start protection circuit (not shown) for countering the impact of a counter electromotive force caused by the frequent starting of the DC motor.

Preferably, the finger 20 further includes a first anti-shock protection circuit (not shown) for countering the impact of a power shock when the finger is connected.

In this embodiment, when the modular dexterous hand is in use, the anti-shock protection circuit is used to counter the impact of the power shock when the fingers need to be replaced online.

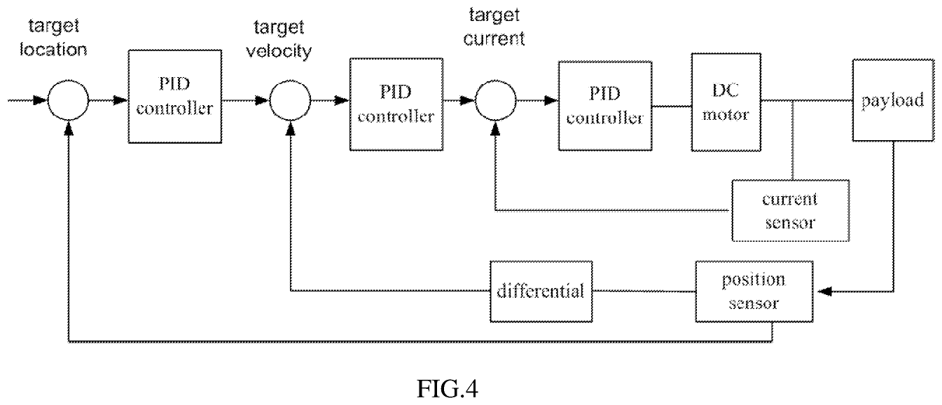

As shown in FIG. 4, the first DC motor 212 and the second DC motor 222 are controlled by a three loop control of “position-speed-current”. The host computer outputs different control instructions to control different control targets, so that the host computer can set different control targets through commands. When the control target is a position value, the three loops of position-speed-current work simultaneously. When the control target is a speed value, the speed-current loop functions. When the control target is a current value, the current loop functions.

The current loop acts as an inner loop, when the DC motor moves, the voltage rises, and the voltage at both ends of the induction resistor rises. A voltage value is obtained via the sampling by the micro-control unit and then converted into a current. At the same time, the current is used as a feedback signal of the output of the finger torque to realize the control of the torque.

The dexterous hand needs to work frequently in the assembled state, by setting the maximum limit current of the DC motor for different drive joints on the hardware and software, the working state of the DC motor is protected and the service life of the DC motor is prolonged. the limitation in hardware is more timely, and the limitation in software ensures that the current is within a controllable range.

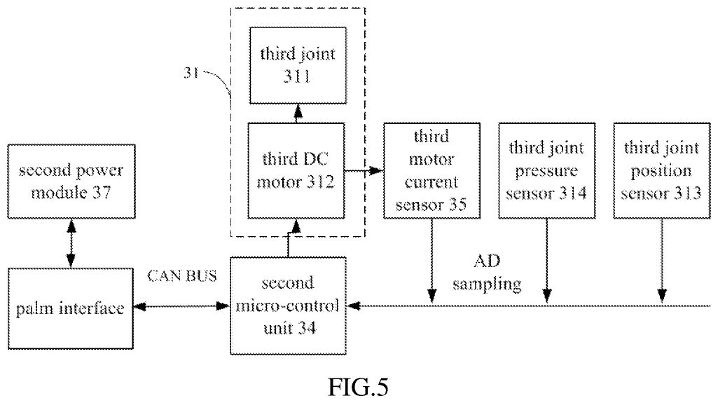

In one embodiment as shown in FIG. 5, the palm 30 and the fingers 20 are compatible in hardware structure. The palm 30 and the finger 20 are compatible, so a same embedded software can be used on the palm 30 and the finger 20.

The palm 30 includes a third joint module 31 and a second micro-control unit 34.

The third joint module 31 includes a third joint 311 and a third DC motor 312, the third DC motor 312 drives the third joint 311 to move.

The second micro-control unit 34 includes a second DC motor driver chip, the second DC motor driver chip includes multiple PWM outputs.

The third DC motor 312 is connected to one output of the second DC motor driver chip.

The second micro-control unit 34 receives the operation instruction sent by the central communication unit 10 via a CAN bus, and converts the operation instruction into the control instruction to control and drive the third DC motor 312 via one channel of PWM output of the second DC motor driver chip, so as to control and drive the third joint 311 connected to the third DC motor 312 to move according to the control instruction of the second micro-control unit 34.

In the embodiment of the invention, the fingers and palm are designed as embedded compatibility standards, making the inquiry response communication reliable and ensure the stability of communication. The palm uses a micro control unit as the processor to control the motors of the palm, the third DC motor is controlled and driven by the second micro-control unit via one PWM output of the second DC motor driver chip, so as to control and drive the third joint connected to the third DC motor to move according to the control instruction of the second micro-control unit.

In one embodiment as shown in FIG. 5, the palm 30 further includes a third motor current sensor 35. The third motor current sensor 35 is serially connected to the third DC motor 312 for sampling the motor driving current of the third DC motor 312. After the motor driving current is amplified (e.g., amplified by an operational amplifier), the actual current of the third joint 311 is converted to obtain after being provided to the second micro-control unit 34 for sampling.

Preferably, the third joint module 31 further includes a third position sensor 313; the third position sensor 313 is embedded in the third joint 311 for detecting the accurate angle of the third joint 311 when the third DC motor 312 drives the third joint 311 to move. Alternatively, the third position sensor 313 is a hall sensor.

Preferably, the third joint module 31 further includes a third joint pressure sensor 314, the third joint pressure sensor 314 is installed at the middle position of the third joint 311 for detecting a pressure value received by the third joint 311, and transmitting the pressure value to the second micro-control unit 34. Specifically, when the third joint 311 is stressed, the third joint pressure sensor 314 detects the change of the resistance value of the third joint 311, and passes the change of the resistance value through the piezoelectric conversion circuit, the actual pressure value received by the third joint 311 is obtained after sampling is provided to the second micro-control unit 34 and converted. Preferably, the third joint pressure sensor 314 is a resistance strain pressure sensor array. Furtherly, the third joint pressure sensor 314 is a resistance strain pressure sensor array.

In this embodiment, the palm includes a variety of sensors such as a current sensor, a position sensor, and a pressure sensor. The micro-control unit acts as a processor to sample various sensors of the palm, the control of multiple target parameters of the modular palm can be realized, so that the dexterous hand has the advantages of high flexibility, high reliability, strong anti-interference and low cost.

In one embodiment as shown in FIG. 5, the palm 30 further includes a second power module 37 for providing power to the palm 30. Preferably, the second power module 37 provides the palm 30 with DC 12V/24V power.

Preferably, the palm 30 further includes a second voltage slow-start protection circuit (not shown) for countering the impact of a counter electromotive force caused by the frequent starting of the DC motor.

Preferably, the palm 30 further includes a second anti-shock protection circuit (not shown) for countering the impact of a power shock when the palm is connected.

In this embodiment, during use of the modular dexterous hand, when the palm needs to be replaced online, the anti-shock protection circuit is used to counter the impact of the power shock.

In the embodiment, the central communication unit 10 communicates with the fingers 20, the palm 30 and the host computer 200, the central communication unit 10 is configured to receive an operation instruction from the host computer 200, and convert the operation instruction into a control instruction and send it to the fingers 20 and the palm 30, and is further configured to read and forward a response data of each finger 20 and the palm 30, and upload the response data to the host computer 200.

Preferably, the central communication unit 10 is also used to monitor the state of each finger 20 to ensure the correctness of the movement of the finger 20 and the accuracy of the response, so as to ensure the normal operation of the finger 20.

Preferably, the central communication unit 10 is also compatible with multiple protocols, so as to ensure support for different platforms. For example, it is compatible with USB (Universal Serial Bus) and CAN (Controller Area Network) protocols to support simultaneous use under USB and CAN.

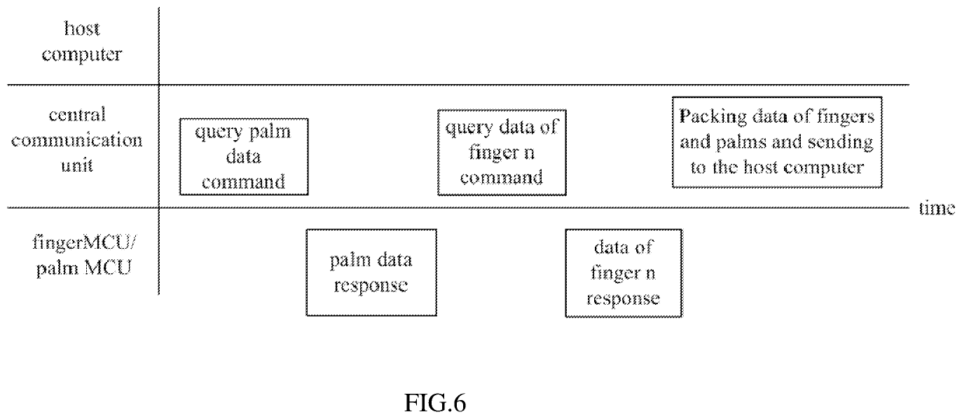

As shown in FIG. 6, the communication between the central communication unit 10 and the host computer 200 is USB or UART (Universal Asynchronous Receiver/Transmitter).

The central communication unit 10 continuously queries the data of the fingers 20 and/or the palm 30, after querying the data, the data of all the fingers 20 and/or the palm 30 is packed and uploaded to the host computer 200, after receiving the finger data, the host computer 200 can judge the characteristics of the fingers 20 when grasping an object in real time, and adjust the posture of the fingers 20 in time according to the judging result.

When the dexterous hand works, it supports online identification of the modular fingers, and supports online replacement of the fingers. By setting different pairs of resistors at different installation positions of the fingers, the central communication unit can determine the position where the dexterous hand is inserted. The finger and the central communication unit knows the CAN ID of the communication by detecting the size of the connection voltage, so as to ensure the finger to communicate normally and stably after the replacement.

In this embodiment, the fingers and palm are designed as embedded compatibility standards, which makes the dexterous hand more flexible and easy to maintain, flexible to use, convenient to maintain. Meanwhile, the fingers are directly driven by multi-motors, effectively ensuring the control performance. The central communication unit communicates with the fingers, the palm and the host computer by serial communication, and the fingers and palm communicate by serial communication, making the inquiry response communication reliable and ensure the stability of communication. The fingers and the palm include a variety of sensors such as a current sensor, a position sensor, and a pressure sensor, the micro-control unit acts as a processor to sample various sensors of the fingers. Meanwhile, by controlling the multi-motors of the fingers and the motor of the palm, the control of multiple target parameters of the modular fingers and the palm is realized. The data of the fingers and the palm are communicated with the host computer via the central communication unit, and the central communication unit is compatible with various protocols, so that the central communication unit is adapt to multiple fingers, and supports online identification of modular fingers and online replacement of the fingers, and maintain stable communication.

It should be noted that, herein, the terms “include”, “comprising” or any other variation thereof are intended to encompass non-exclusive inclusion, such that a process, method, article or device comprising a series of elements not only includes those elements, but also other elements not expressly listed or inherent to such a process, method, article or apparatus. Without further limitation, an element qualified by the phrase “comprising a . . . ” does not preclude the presence of additional identical elements in a process, method, article or apparatus that includes the element.

The above-mentioned serial numbers of the embodiments of the present invention are only for description, and do not represent the embodiments are in any order.

Based on the description of the above embodiments, those skilled in the art clearly understand that the method of the above embodiments are implemented by means of software along with a necessary general hardware platform, alternatively implemented by a hardware, in many cases the former is better. up, the technical solution of the present invention, or the part that contributes to the prior art, can be embodied in the form of a software product, and the computer software product is stored in a storage medium (such as ROM/RAM, magnetic disk, CD), including several instructions to make a terminal (which may be a mobile phone, a computer, a server, an air conditioner, or a network device, etc.) execute the methods described in the various embodiments of the present invention. In summary, the technical solution of the present invention in essence or the part that contributes to the prior art is embodied in the form of a software product. The computer software product is stored in a storage medium (such as ROM/ram, diskette, optical disc) and includes several instructions to enable a terminal (which can be a mobile phone, a computer, a server, an air conditioner, or a network device) to execute the method described in each embodiment of the present invention.

The above embodiments, which are intended to enable those skilled in the art to understand the content of the disclosure and implement it accordingly, are merely for describing the technical concepts and features of the disclosure, and the scope of patent application of the disclosure cannot be defined only by the embodiments, i.e., any equivalent variations or modifications made in accordance with the spirit disclosed by the disclosure still fall within the scope of claims of the disclosure.

What is claimed is:

1. An embedded system for dexterous hand, comprising:
a central communication unit,
several fingers,
a palm; wherein
the central communication unit communicates with the fingers, the palm and a host computer respectively, the central communication unit is configured to receive an operation instruction from the host computer, and convert the operation instruction into a control instruction and send it to the fingers and the palm;
the fingers and the palm are designed to be compatible in hardware structure, and are connected by serial communication;
the fingers and the palm both move according to the control instructions.

2. The system as defined in claim 1, wherein the finger comprises a first joint module, a second joint module, and a first micro-control unit;
the first joint module includes a first joint and a first DC motor connected thereto, the first DC motor drives the first joint to move;
the second joint module includes a second joint and a second DC motor connected thereto, the second DC motor drives the second joint to move;
the first micro-control unit includes a first DC motor driver chip, the first DC motor driver chip includes multiple pulse width modulation (PWM) outputs;
the first DC motor and the second DC motor are respectively connected with one PWM output of the first DC motor driver chip;
the first micro-control unit receives the operation instruction sent by the central communication unit via a CAN bus, and converts the operation instruction into the control instruction to control and drive the first DC motor and the second DC motor respectively via two PWM outputs of the first DC motor driver chip, so as to control and drive the first joint connected to the first DC motor and the second joint connected to the second DC motor to move according to the control instruction of the first micro-control unit.

3. The system as defined in claim 2, wherein the finger further includes a first motor current sensor and a second motor current sensor;
the first motor current sensor configured to sample the motor driving current of the first DC motor, the actual current value received by the first joint is obtained after sampling is provided to the first micro-control unit and converted;
the second motor current sensor configured to sample the motor driving current of the second DC motor, the actual current value received by the second joint is obtained after sampling is provided to the first micro-control unit and converted.

4. The system as defined in claim 2, wherein the first joint module further includes a first position sensor and a first joint pressure sensor; the first position sensor is embedded in the first joint for detecting the accurate angle of the first joint when the first DC motor drives the first joint to move; the first joint pressure sensor is installed at the middle position of the first joint for detecting a pressure value received by the first joint, and transmitting the pressure value to the first micro-control unit.

5. The system as defined in claim 2, wherein the second joint module further includes a second position sensor and a second joint pressure sensor; the second position sensor is embedded in the second joint for detecting the accurate angle of the second joint when the second DC motor drives the second joint to move; the second joint pressure sensor is installed at the middle position of the second joint for detecting a pressure value received by the second joint, and transmitting the pressure value to the first micro-control unit.

6. The system as defined in claim 2, wherein the finger further includes a first voltage slow-start protection circuit for countering the impact of a counter electromotive force caused by the frequent starting of the DC motor.

7. The system as defined in claim 2, wherein the finger further includes a first anti-shock protection circuit for countering the impact of a power shock when the finger is connected.

8. The system as defined in claim 1, wherein the palm includes a third joint module and a second micro-control unit; the third joint module includes a third joint and a third DC motor, the third DC motor drives the third joint to move; the second micro-control unit includes a second DC motor driver chip, the second DC motor driver chip includes multiple PWM outputs; the third DC motor is connected to one output of the second DC motor driver chip; the second micro-control unit receives the operation instruction sent by the central communication unit via a CAN bus, and converts the operation instruction into the control instruction to control and drive the third DC motor via one channel of PWM output of the second DC motor driver chip, so as to control and drive the third joint connected to the third DC motor to move according to the control instruction of the second micro-control unit.

9. The system as defined in claim 8, wherein the palm further includes a third motor current sensor, a third position sensor and a third joint pressure sensor; the third motor current sensor configured to sample the motor driving current of the third DC motor, provided to the second micro-control unit for sampling, and then converted to obtain the actual current of the third joint; the third position sensor is embedded in the third joint for detecting the accurate angle of the third joint when the third DC motor drives the third joint to move; the third joint pressure sensor is installed at the middle position of the third joint for detecting the pressure value received by the third joint, and transmitting the pressure value to the second micro-control unit.

10. The system as defined in claim 8, wherein the palm further includes a second voltage slow-start protection circuit for countering the impact of a counter electromotive force caused by the frequent starting of the DC motor.

11. The system as defined in claim 8, wherein the palm further includes a second anti-shock protection circuit for countering the impact of a power shock when the palm is connected.

12. The system as defined in claim 1, wherein the central communication unit is further configured to read and forward a response data of each finger and the palm, and upload the response data to the host computer.
